(19) United States
(12) Patent Application Publication
(10) Pub. No.: US 2011/0318495 A1
(43) Pub. Date: Dec. 29, 2011

(54) AQUEOUS COATING MATERIAL, ITS PREPARATION AND USE

(75) Inventors: Bernhard Steinmetz, Rutschenhausen (DE); Claudia Schneider, Arnstein-Mudesheim (DE); Anke Küdde, Guentersleben (DE)

(73) Assignee: BASF COATINGS AG, Munster (DE)

(21) Appl. No.: 12/673,248

(22) PCT Filed: Aug. 13, 2008
(86) PCT No.: PCT/EP2008/006654

§ 371 Date: Sep. 14, 2011

(30) Foreign Application Priority Data
Aug. 14, 2007 (DE) 102007038487.6

(51) Int. Cl. B05D 1/36; C09D 5/00; C09D 175/14; C09D 175/04; C09D 151/08

(52) U.S. Cl. 427/407.1; 524/591; 524/507

(57) ABSTRACT

The present invention relates to an aqueous coating material comprising at least one ionically and/or nonionically stabilized polyurethane, which is saturated, unsaturated and/or grafted with olefinically unsaturated compounds, and at least one organic, aliphatic solvent, wherein said solvent has a solubility parameter δ<10 (cal/cm³)^{1/2} and a degree of branching corresponding to a ratio of the number of CH and CH₂ groups to the number of CH₃ groups of at least 25:75. The invention further relates to a process for preparing it and to its use.

### FIELD OF THE INVENTION

The present invention relates to a new aqueous coating material comprising at least one ionically and/or nonionically stabilized polyurethane, which is saturated, unsaturated and/or grafted with olefinically unsaturated compounds, and at least one organic, aliphatic, unfunctionalized solvent. Additionally, the present invention relates to a new process for preparing an aqueous coating material. The present invention further relates to the use of the new coating material and of the aqueous coating material prepared by the new process.

### PRIOR ART

Aqueous coating materials comprising at least one ionically and/or nonionically stabilized polyurethane which is saturated, unsaturated and/or grafted with olefinically unsaturated compounds are known. They may be cured physically, thermally, or both thermally and with actinic radiation. Preferably they comprise color and/or effect pigments and are used for producing color and/or effect paint coats, more particularly basecoats as part of multicoat paint systems, or solid-color topcoats.

The known aqueous coating materials may comprise organic solvents, more particularly high-boiling organic solvents, such as heterocyclic, aliphatic or aromatic hydrocarbons, monohydric or polyhydric alcohols, ethers, esters, and ketones, such as, for example, N-methylpyrrolidone, toluene, xylene, butanol, ethylene glycol and butylglycol and their acetates, butyldiglycol, ethylene glycol dibutyl ether, diethylene glycol dibutyl ether, ethoxypropanol, cyclohexanone, methyl ethyl ketone, acetone or isophorone, (cf. the European patent applications EP 0 228 003 A1 and EP 0 634 431 A1).

The very low solubility of silicones in water and aqueous systems means that contamination of aqueous coating materials can lead to wetting defects in the paint coat. A person skilled in the art will distinguish between the following phenomena that may appear in a basecoat-plus-clearcoat system:
wetting defects in the clearcoat over a coherent basecoat film (A craters);
wetting defects in both the clearcoat and the basecoat over a coherent surfacer film (C craters);
wetting defects in the basecoat over a coherent surfacer film, the clearcoat forming a coherent film over the wetting defect site (D craters).

To date there are no known documents describing means of minimizing or avoiding the defects induced by silicone contamination.

JP 2000-246324 describes the use of hydrophobic organic solvents to improve repairability and water resistance. JP 2000-390442 likewise describes the use of aliphatic hydrocarbons to improve water resistance. As well as the improvement of water resistance, US 1988-155458 also describes the stabilization of nonpolar organic polymers in aqueous formulations through use of hydrophobic organic solvents. This property is described as well by JP 2000-369981 and JP 1977-41159.

### Problem Addressed by the Invention

The problem on which the present invention is based is that of providing a new aqueous coating material, comprising at least one ionically and/or nonionically stabilized polyurethane, saturated, unsaturated and/or grafted with olefinically unsaturated compounds, said material being easy to prepare and no longer exhibiting the craters after spray application, even in the event of contamination with silicones.

The new aqueous coating material ought more particularly to be suitable as an aqueous basecoat material for producing color and/or effect basecoats of multicoat paint systems by the wet-on-wet method. The paint films should no longer exhibit any craters, even in the event of silicone contamination.

The new aqueous coating material is intended to yield coatings, preferably color and/or effect coatings, more preferably basecoats and solid-color topcoats, more particularly basecoats in multicoat paint systems, which even in the event of contamination with silicones are entirely or very largely free from paint defects such as craters and also, preferably, from pops and pinholes.

### Solution Provided by the Invention

The problems identified above are solved by a coating material of the type specified at the outset wherein the solvent has a solubility parameter δ<10 (cal/cm³)^{1/2} and a degree of branching corresponding to the ratio of the number of CH and CH₂ groups to the number of CH₃ groups of at least 25:75. The solubility parameter here is the Hildebrand solubility parameter, which is described in J. Am. Chem. Soc., 51, pp. 66-80, 1929.

Also found has been the new process for preparing the aqueous coating material of the invention, which comprises mixing together at least one ionically and/or nonionically stabilized polyurethane, which is saturated, unsaturated and/or grafted with olefinically unsaturated compounds, at least one wetting agent or dispersant, and at least one organic, aliphatic, unfunctionalized solvent selected from the group of hydrocarbons consisting of branched isomers of octane, nonane, decane, undecane, dodecane, tridecane, tetradecane, pentadecane, hexadecane, heptadecane, octadecane, nonadecane, eicosane, heneicosane, docosane, tricosane, tetracosane, and pentacosane.

Found not least has been the new use of the coating material of the invention, and of the coating material prepared by the process of the invention, for producing multicoat color and/or effect paint systems, this being referred to below as “inventive use”.

Additional subject matter of the invention will become apparent from the claims and from the description which now follows.

### Advantages of the Invention

In light of the prior art it is surprising and was unforeseeable for the skilled worker that the problem on which the present invention is based is achieved by means of the coating material of the invention, the process of the invention, and the inventive use.

A particular surprise is that the coating material of the invention is simple to prepare, no longer includes any toxicologically objectionable ingredients, and following spray application exhibits no—or very few—craters, pops, and pinholes.

Surprisingly the coating material of the invention can be used in the context of the inventive use as an aqueous basecoat material for producing color and/or effect basecoats of multicoat paint systems by the wet-on-wet method. In this application the coating exhibits very few, if any, craters, even in the event of contamination with silicones.

In the context of the inventive use, the coating material of the invention yields coatings of the invention, preferably color and/or effect coatings, more preferably basecoats and solid-color topcoats, more particularly basecoats in multicoat paint systems, which even in the event of silicone contamination are entirely or very largely free from paint defects such as craters, pops, and pinholes. Furthermore, the coatings have a particularly high hiding power and an outstanding overall visual appearance. The coating material of the invention is therefore outstandingly suitable for the finishing of automobile bodies.

### DETAILED DESCRIPTION OF THE INVENTION

The coating material of the invention is curable physically, thermally, or both thermally and with actinic radiation. The thermal cure, or both thermal and actinic radiation cure, may be assisted by the physical curing.

For the purposes of the present invention the term “physical curing” means the curing of a layer of a coating material by filming, where appropriate after drying of the layer. Typically no crosslinking agents are necessary for this cure. Where appropriate the physical curing may be assisted by atmospheric oxygen or by exposure to actinic radiation.

For the purposes of the present invention the term “thermal curing” denotes the heat-initiated curing of a layer of a coating material where typically a separate crosslinking agent is employed. The crosslinking agent comprises reactive functional groups which are complementary to the reactive functional groups present in the polyurethanes. This is typically referred to by those in the art as external crosslinking. Where the complementary reactive functional groups or autoreactive functional groups, i.e., groups which react “with themselves”, are already present in the polyurethanes, the latter are self-crosslinking. Examples of suitable complementary reactive functional groups and autoreactive functional groups are known from German patent application DE 199 30 665 A1, page 7 line 28 to page 9 line 24.

Actinic radiation for the purposes of the present invention means electromagnetic radiation such as near infrared (NIR), visible light, UV radiation, X-rays or gamma radiation, more particularly UV radiation, and particulate radiation such as electron beams, beta radiation, alpha radiation, proton beams or neutron beams, more particularly electron beams. Curing by UV radiation is typically initiated by free-radical or cationic photoinitiators.

Where thermal curing and curing with actinic light are employed jointly in the context of the coating material of the invention, another term used is “dual cure”.

The coating material of the invention may be a one-component (1K) system.

For the purposes of the present invention a one-component (1 K) system may be a thermosetting coating material in which the binder and the crosslinking agent are present alongside one another, i.e., in one component. A prerequisite for this is that the two constituents crosslink with one another only at relatively high temperatures and/or on exposure to actinic radiation.

The coating material of the invention may further be a two-component (2K) or multicomponent (3K, 4K) system.

For the purposes of the present invention this means a coating material in which more particularly the binder and the crosslinking agent are present separately from one another in at least two components, which are only combined a short time before application. This form is chosen when binder and crosslinking agent react with one another even at room temperature. Coating materials of this kind are employed primarily in the coating of thermally sensitive substrates, more particularly in automotive refinish.

The first key constituent of the coating material of the invention is at least one ionically and/or nonionically stabilized polyurethane which is saturated, unsaturated and/or grafted with olefinically unsaturated compounds and is based preferably on aliphatic, cycloaliphatic, aliphatic-cycloaliphatic, aromatic, aliphatic-aromatic and/or cycloaliphatic-aromatic polyisocyanates. For stabilization the polyurethane contains alternatively
functional groups which can be converted by neutralizing agents and/or quaternizing agents into cations, and/or cationic groups, or
functional groups which can be converted by neutralizing agents into anions, and/or anionic groups, and/or
nonionic hydrophilic groups.

Suitable polyurethanes are known for example from
German patent application DE 199 14 98 A1, column 1 lines 29 to 49 and column 4 line 23 to column 11 line 5,
German patent application DE 199 48 004 A1, page 4 line 19 to page 13 line 48,
European patent application EP 0 228 003 A1, page 3 line 24 to page 5 line 40,
European patent application EP 0 634 431 A1, page 3 line 38 to page 8 line 9, or
International patent application WO 92/15405, page 2 line 35 to page 10 line 32.

In the coating material of the invention they are present in the typical and known amounts.

Where the coating material of the invention is curable physically, with thermal self-crosslinking, or with thermal self-crosslinking and with actinic radiation, its polyurethane content is preferably 50% to 100%, more preferably 50% to 90%, and in particular 50% to 80% by weight, based in each case on the film-forming solids of the coating material of the invention.

Where the coating material of the invention is curable with thermal external crosslinking, or with thermal external crosslinking and with actinic radiation, its polyurethane content is preferably 10% to 80%, more preferably 15% to 75%, and more particularly 20% to 70% by weight, based in each case on the film-forming solids of the coating material of the invention.

Aliphatic solvents are used which have a solubility parameter δ<10 (cal/cm³)^{1/2} and a degree of branching, characterized by the ratio of the number of CH and CH₂ groups to the number of CH₃ groups, of at least 25:75.

The organic solvents are typical and known products available commercially. By way of example they are sold under the Isopar® brand name by the company Exxon.

The amount of the organic solvent may vary widely and in this way may be tailored to the requirements of the case in hand. In light of the aqueous nature of the coating material of the invention, however, there is concern to minimize its organic solvent content. In this context it is a particular advantage that an organic solvent content for the coating material of the invention of 0.1% to 10%, preferably 0.5% to 7%, and more particularly 0.5% to 5% by weight, based in each case on the coating material of the invention, is sufficient to obtain the advantageous technical effects of the invention.

The coating material of the invention may further comprise at least one additive. Preferably it comprises at least two additives. The additive is preferably selected from the group of the additives that are typically used in the field of coating materials. With particular preference the additive is selected from group consisting of salts which can be decomposed thermally without residue or substantially without residue, binders, other than the polyurethanes, which are curable physically, thermally and/or with actinic radiation, crosslinking agents, organic solvents other than the organic solvents, thermally curable reactive diluents, reactive diluents curable with actinic radiation, color and/or effect pigments, transparent pigments, fillers, molecularly dispersely soluble dyes, nanoparticles, light stabilizers, antioxidants, devolatilizers, emulsifiers, slip additives, polymerization inhibitors, free-radical polymerization initiators, thermolabile free-radical initiators, adhesion promoters, flow control agents, film-forming assistants, such as thickeners and structurally viscous sag control agents, SCAs, flame retardants, corrosion inhibitors, free-flow aids, waxes, siccatives, biocides, and matting agents.

Suitable additives of the aforementioned kind are known for example from
German patent application DE 199 48 004 A1, page 14 line 4 to page 17 line 5,
German patent application DE 199 14 98 A1, column 11 line 9 to column 15 line 63, or
German patent DE 100 43 405 C1, column 5, paragraphs [0031] to [0033].

They are used in the typical and known effective amounts.

The solids content of the coating material of the invention may vary very widely and can therefore be tailored to the requirements of the case in hand. The solids content is guided primarily by the viscosity necessary for application, more particularly spray application, and so the solids content can be adjusted by the skilled worker on the basis of his or her general art knowledge, with the assistance where appropriate of a few rangefinding tests. Preferably the solids content is 5% to 70%, more preferably 10% to 65%, and more particularly 15% to 60% by weight, based in each case on the coating material of the invention.

The coating material of the invention is preferably prepared by means of the process of the invention. In that case the constituents described above are dispersed in an aqueous medium, more particularly in water, and then the resulting mixture is homogenized. Viewed in terms of its method, the process of the invention has no special features, but can instead be carried out with the aid of the typical and known mixing methods and mixing assemblies, such as stirred tanks, dissolvers, stirrer mills, compounders, static mixers or extruders.

With particular preference the coating materials of the invention are used as solid-color topcoat materials for producing one-coat solid-color topcoats, or as aqueous basecoat materials for producing multicoat color and/or effect paint systems. With very particular preference they are used as aqueous basecoat materials for producing color and/or effect basecoats of multicoat paint systems, preferably multicoat paint systems for automobile bodies. In this context they are outstandingly suitable for OEM finishing and for refinish.

With very particular preference the multicoat paint systems of the invention are produced by wet-on-wet methods in which
(1) at least one aqueous basecoat material is applied to a primed or unprimed substrate to give at least one aqueous basecoat film (1),
(2) at least one clearcoat material is applied to the aqueous basecoat film (1) to give at least one clearcoat film (2), and
(3) at least the aqueous basecoat film(s) (1) and the clearcoat film(s) (2) are jointly cured to give the basecoat (1) and the clearcoat (2).

Examples of such wet-on-wet methods are known from
German patent application DE 199 48 004 A1, page 17 line 37 to page 19 line 22, or
German patent DE 100 43 405 C1, column 3, paragraph [0018], and column 8, paragraph [0052] to column 9, paragraph [0057], in conjunction with column 6, paragraph [0039] to column 8, paragraph [0050].

The film thicknesses described therein for the individual coats of the multicoat paint system of the invention are employed.

### EXAMPLES

### Preparation Example 1

### The Preparation of a Gray Aqueous Basecoat Material 1

For better assessment of any paint defects occurring, a gray aqueous basecoat material was used that was prepared in accordance with the following instructions.

Mixture 1a:

A dissolver was charged with 26 parts by weight of an inorganic thickener (sodium magnesium phyllosilicate, 3% by weight in water). Added to this initial charge with stirring were 30 parts by weight of deionized water, 107.5 parts by weight of butylglycol, 4.5 parts by weight of a polyurethane-modified polyacrylate prepared according to page 7 line 55 to page 8 line 23 of German patent application DE 44 37 535 A1, and 0.6 part by weight of a 20.5% by weight solution of a commercial defoamer, Nopco® DSX 1550. This gave the mixture 1a.

Mixture 1b:

Separately, 3.2 parts by weight of an aqueous polyester resin dispersion prepared according to Example D., column 16 lines 37 to 59, of German patent application DE 40 09 858 A1, 0.3 parts by weight of a surfactant solution containing 52% by weight of Surfynol® 104 from Air Products, 55 parts by weight of butylglycol, 4.1 parts by weight of a commercial, water-dilutable melamine-formaldehyde resin in n-butanol (Cymel® 203 from Surface Specialties Austria), and 0.3 part by weight of a 10% strength by weight solution of dimethylethanolamine in water were mixed together. This gave the mixture 1b.

Mixture 1c:

Mixtures 1a and 1b were mixed together. This gave the mixture 1c.

Mixture 1d:

Mixture 1c was admixed with 6 parts by weight of deionized water, 20.4 parts by weight of a polyurethane-modified polyacrylate prepared according to page 19 line 44 to page 20 line 7 of German patent application DE 199 48 004 A1, 1.6 parts by weight of surfactant solution containing 52% by weight of Surfynol® 104, 48 parts by weight of butoxyethanol, 0.4 part by weight of a 10% strength by weight solution of dimethylethanolamine in water, 1.6 parts by weight of n-butanol and 3.9 parts by weight of a 3% by strength by weight solution of a polyacrylate thickener (Viscalex® from Ciba). This gave the mixture 1d.

Carbon Black Paste:

The carbon black paste was prepared from 25 parts by weight of a polyacrylate dispersion prepared according to international patent application WO 91/15528, 10 parts by weight of carbon black, 0.1 part by weight of methyl isobutyl ketone, 1.36 parts by weight of dimethylethanolamine, 2 parts by weight of a commercial polyether (Pluriol® P900 from BASF Aktiengesellschaft), and 61.45 parts by weight of deionized water.

Blue Paste 1:

Blue paste 1 was prepared from 19.4 parts by weight of a polyurethane dispersion prepared according to column 16 lines 10 to 35 of German patent application DE 40 09 858 A1, 13.5 parts by weight of Paliogen® Blau L 6482, 4.3 parts by weight of butoxyethanol, 0.18 part by weight of methyl ethyl ketone, 0.62 part by weight of dimethylethanolamine, 1.2 parts by weight of Pluriol® P900, and 61 parts by weight of water.

Blue Paste 2:

Blue paste 2 was prepared from 15.4 parts by weight of a polyacrylate dispersion prepared according to international patent application WO 91/15528, 30 parts by weight of Paliogen® Blau L 6470, 2.6 parts by weight of Disperbyk® 184, 1.6 parts by weight of dipropylene glycol monomethyl ether, 0.1 part by weight of methylisobutyl ketone, 0.65 part by weight of dimethylethanolamine, 0.8 part by weight of 1,2-propylene glycol, and 45 parts by weight of deionized water.

Violet Paste:

The violet paste was prepared from 23 parts by weight of an aqueous polyurethane dispersion prepared according to Example 1, page 14 line 13 to page 15 line 27, of international patent application WO 92/15405, 18.4 parts by weight of Quindo Violet® 19 228-690, 2.5 parts by weight of butylglycol, 0.2 part by weight of methyl ethyl ketone, 0.26 part by weight of dimethylethanolamine, 2 parts by weight of Pluriol® P900, and 51 parts by weight of deionized water.

Paste Mixture:

The paste mixture was prepared from 2.5 parts by weight of the carbon black paste, 1.0 part by weight of blue paste 1, 0.3 part by weight of blue paste 2, 0.75 part by weight of the violet paste, and 0.5 part by weight of a paste prepared according to Example 1 of German patent application DE 100 04 494 A1.

Mixture 1e:

Mixture 1e was prepared from the paste mixture and mixture 1d.

Aluminum Effect Pigment Paste:

The aluminum effect pigment paste was prepared from 0.18 parts by weight of a first 65% by weight pasted aluminum effect pigment (Alu-Stapa-Hydrolux® 2153 from Eckart) and a second 65% by weight pasted aluminum effect pigment (Alu-Starter-Hydrolux 8154 from Eckart), 0.55 part by weight of butylglycol, and 0.28 part by weight of the aqueous polyester resin dispersion prepared according to Example D., column 16 lines 37 to 59, of German patent application DE 40 09 858 A1.

Aqueous Basecoat Material 1:

Aqueous basecoat material 1 was prepared from mixture 1e, the aluminum effect pigment paste, and two parts by weight of water. It was subsequently adjusted with dimethylethanolamine to a pH of 8 and with deionized water to a viscosity of 58 mPas under a shearing load of 1000/second at 23° C.

Aqueous Basecoat Material C1:

Aqueous basecoat material C1 was prepared by admixing aqueous basecoat material 1 of Preparation Example 1 with 0.1 ppm of Wacker AK 1000® Silicone Fluid.

Aqueous Basecoat Material I2:

The inventive aqueous basecoat material I2 was prepared by admixing aqueous basecoat material C1 with the commercially available solvent Isopar L®.

TABLE 1
Composition of aqueous basecoat materials C1 and I2

| ABM | [% by weight] | Solvent |
|---|---|---|
| C1 | — | — |
| I2 | 2.5 | Isopar L ® |

The weight percent figures of Table 1 are based on the respective aqueous basecoat material.

For determination of the craters, the multicoat paint systems C1 and I2 were produced in accordance with the following general instructions:

An aluminum panel measuring 40×40 cm was coated with a film thickness of 8-12 μm, which is less than the process film thickness. The resulting panel was subsequently dried at 80° C. for 10 minutes and a typical and known two-component clearcoat material was applied to the dried aqueous basecoat film. The aqueous basecoat film and clearcoat film were then cured in a forced-air oven at 140° C. for 20 minutes. The number of craters in the multicoat paint system was determined visually. Table 2 gives an overview of the experimental results.

TABLE 2
Craters in the multicoat paint systems C1 and I2

| Inventive/comparative | Sum of the craters | |
|---|---|---|
| example | over 3 panels | Rating |
| C1 | 311 | not OK |
| I2 | 0 | OK |

The experimental results of Table 2 underline the fact that the organic solvents have a crater-reducing action or crater prevention effect in paint systems of silicone-contaminated aqueous coating materials.

### Preparation Example 2

### The Preparation of Aqueous Basecoat Material C3

Aqueous basecoat material C3 was prepared by mixing aqueous basecoat material C1 of Preparation Example 1 with 2.5% by weight of Shellsol T® from Shell and adjusting the mixture with deionized water to a viscosity of 70 to 75 mPas under a shearing load of 1000/second at 23° C.

### Comparison Experiment Between I2 and C3

For the determination of the pinholing limit and number of pinholes, the multicoat paint systems were produced in accordance with the following general instructions:

A steel panel coated with a surfacer coat and measuring 30×50 cm was provided on one long edge with an adhesive strip, in order to be able to determine the differences in film thickness after coating. The aqueous basecoat material was applied electrostatically in the form of a wedge.

The resulting aqueous basecoat film was flashed off at room temperature for a minute and then dried in a forced-air oven at 70° C. for 10 minutes. A typical and known two-component clearcoat material was applied to the dried aqueous basecoat film. The resulting clearcoat film was flashed off at room temperature for 20 minutes. The aqueous basecoat film and the clearcoat film were subsequently cured in a forced-air oven at 140° C. for 20 minutes. Following visual evaluation of the pinholes in the resulting wedge-shaped multicoat paint system, the film thickness of the pinholing limit was ascertained. The results are found in Table 3.

TABLE 3
Pinholing limit and number of pinholes for C3 and I2

| Inventive/comparative | Pinholing | Number of |
|---|---|---|
| Example | limit (μm) | pinholes |
| C3 | 19 | 34 |
| I2 | 21 | 5 |

The results underline the fact that the use of the organic solvent Isopar significantly increases the pinholing limit by comparison with the commercially available Shellsol, and at the same time the number of pinholes falls significantly.

### Preparation Example 3

### The Preparation of Aqueous Basecoat Material C1-1

Aqueous basecoat material C1-1 was prepared by admixing aqueous basecoat material 1 of Preparation Example 1 with 0.06 ppm of Wacker AK 1000® Silicone Fluid.

### The Preparation of Aqueous Basecoat Material I3

The inventive aqueous basecoat material I3 was prepared by admixing aqueous basecoat material C1-1 with 2.5% by weight, based on the overall aqueous basecoat material I3, of the commercially available solvent dodecane.

### Comparison Experiment Between C1-1 and I3

For determination of the craters, the multicoat paint systems C1-1 and I3 were produced in accordance with the general instructions specified in Preparation Example 1.

The number of craters in the multicoat paint system was determined visually. Table 4 gives an overview of the experimental results.

TABLE 4
Craters in the multicoat paint systems C1-1 and I3

| Inventive/comparative | Sum of the craters | |
|---|---|---|
| example | over 3 panels | Rating |
| C1-1 | 93 | not OK |
| I3 | 2 | OK |

The experimental results of Table 4 underline the fact that the organic solvents have a crater-reducing action or crater prevention effect in paint systems of silicone-contaminated aqueous coating materials.

### Preparation Example 4

### The Preparation of Aqueous Basecoat Material C1-2

Aqueous basecoat material C1-2 was prepared by admixing aqueous basecoat material 1 of Preparation Example 1 with 0.1 ppm of Wacker AK 1000® Silicone Fluid.

### The Preparation of Aqueous Basecoat Material I4

The inventive aqueous basecoat material I4 was prepared by admixing aqueous basecoat material C1-2 with 2.5% by weight, based on the overall aqueous basecoat material I4, of the commercially available solvent Exxsol D 60®.

### Comparison Experiment Between C1-2 and I4

For determination of the craters, the multicoat paint systems C1-2 and I4 were produced in accordance with the general instructions specified in Preparation Example 1.

The number of craters in the multicoat paint system was determined visually. Table 5 gives an overview of the experimental results.

TABLE 5
Craters in the multicoat paint systems C1-2 and I4

| Inventive/comparative | Sum of the craters | |
|---|---|---|
| example | over 3 panels | Rating |
| C1-2 | 266 | not OK |
| I4 | 7 | OK |

The experimental results of Table 5 underline the fact that the organic solvents have a crater-reducing action or crater prevention effect in paint systems of silicone-contaminated aqueous coating materials.

1. An aqueous coating material comprising at least one ionically and/or nonionically stabilized polyurethane, which is saturated, unsaturated and/or grafted with olefinically unsaturated compounds, and at least one organic, aliphatic, unfunctionalized, branched solvent comprising a solubility parameter δ<10 (cal/cm³)^{1/2} and a degree of branching corresponding to a ratio of the number of CH and CH₂ groups to the number of CH₃ groups of at least 25:75.

2. The coating material of claim 1, wherein the degree of branching corresponds to a ratio of the number of CH and CH₂ groups to the number of CH₃ groups of 30:70.

3. The coating material of claim 1, wherein the organic, aliphatic, unfunctionalized, branched solvent is liquid at 25° C. and has a carbon number of 7 to 25.

4. The coating material of claim 1, wherein the organic, aliphatic, unfunctionalized, branched solvent is selected from the group of hydrocarbons consisting of branched isomers of octane, nonane, decane, undecane, dodecane, tridecane, tetradecane, pentadecane, hexadecane, heptadecane, octadecane, nonadecane, eicosane, heneicosane, docosana, tricosane, tetracosane, and pentacosane.

5. The coating material of claim 1, which further comprises at least one additive.

6. The coating material of claim 5, wherein said additive is selected from the group consisting of salts which can be decomposed thermally without residue or substantially without residue, binders, other than the polyurethanes, which are curable physically, thermally and/or with actinic radiation, crosslinking agents, organic solvents other than the at least one organic, aliphatic, unfunctionalized, branched solvent, thermally curable reactive diluents, reactive diluents curable with actinic radiation, color and/or effect pigments, transparent pigments, fillers, molecularly dispersely soluble dyes, nanoparticles, light stabilizers, antioxidants, devolatilizers, emulsifiers, slip additives, polymerization inhibitors, free-radical polymerization initiators, thermolabile free-radical initiators, adhesion promoters, flow control agents, film-forming assistants, rheological assistants, corrosion inhibitors, free-flow aids, waxes, siccatives, biocides, and matting agents.

7. A process for preparing the aqueous coating material of claim 1, which comprises mixing together at least one ionically and/or nonionically stabilized polyurethane, which is saturated, unsaturated and/or grafted with olefinically unsaturated compounds, at least one wetting agent or dispersant, and at least one organic, aliphatic, unfunctionalized branched solvent selected from the group of hydrocarbons consisting of branched isomers of octane, nonane, decane, undecane, dodecane, tridecane, tetradecane, pentadecane, hexadecane, heptadecane, octadecane, nonadecane, eicosane, heneicosane, docosane, tricosane, tetracosane, and pentacosane.

8. A method of producing multicoat color and/or effect paint systems, comprising applying the aqueous coating material prepared by the process of claim 7 as an aqueous basecoat material to a substrate.

9. The method of claim 8, wherein the multicoat color and/or effect paint systems are produced by the wet-on-wet method.

10. The method of claim 8, wherein the substrate is an automobile body or part thereof.

11. The coating material of claim 1, wherein the degree of branching corresponds to a ratio of the number of CH and CH2 groups to the number of CH3 groups of 40:60.

12. The coating material of claim 1, wherein the degree of branching corresponds to a ratio of the number of CH and CH2 groups to the number of CH3 groups of 45:55.
